(19) United States
(12) Patent Application Publication
(10) Pub. No.: US 2005/0076376 A1
(43) Pub. Date: Apr. 7, 2005

(54) Video entertainment satellite network system

(76) Inventor: Raymond Lind, Chicago, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/627,295

(22) Filed: Jul. 24, 2003

Related U.S. Application Data
(60) Provisional application No. 60/398,218, filed on Jul. 24, 2002.
(60) Provisional application No. 60/414,702, filed on Sep. 30, 2002.

(51) Int. Cl. H04N 7/16; H04N 7/173

(52) U.S. Cl. 725/87; 725/25; 725/62

(57) ABSTRACT

A video entertainment satellite network system includes a plurality of individual video entertainment satellite systems that communicate with each other through the video entertainment satellite network system. The video entertainment satellite network system will allow a user of the system to play, record, and interact in selection of video music, perform Karaoke, record live events, and distribute real-time signals to other video entertainment satellite systems in the video entertainment satellite network system by two-way satellite and internet communication.

### RELATED APPLICATIONS

This application claims priority from U.S. Provisional Application Ser. No. 60/398,218, filed Jul. 24, 2002, and U.S. Provisional Application Ser. No. 60/414,702, filed Sep. 30, 2002, the disclosures of which are incorporated herein by reference.

### FIELD OF THE DISCLOSURE

The present disclosure relates to video entertainment systems, and more particularly, to a video entertainment satellite network system.

### BACKGROUND

Audio jukeboxes, video jukeboxes and Karaoke machines are often available in various entertainment establishments to provide patrons with single or group entertainment options. Audio jukeboxes typically have an internal collection of music compact discs that can be selected by a user for single or repeated play over internal speakers or speakers positioned at various locations in the proximity of the jukebox. Video jukeboxes typically have an internal collection of music videos on digital video discs that can be selected by a user for single or repeated play over internal monitors or monitors positioned at various locations in the proximity of the jukebox. Both audio and video jukeboxes are non-interactive, that is, the user only selects the music or music video to be played and cannot interact with the jukebox. Karaoke machines, on the other hand, play a song without the lyrics and display to a user the lyrics on a video monitor so that the user can sing along or substitute for the original artist of the song. Accordingly, Karaoke machines are interactive and provide user participation.

The foregoing entertainment machines only have a limited selection of songs from which a user can select. The number of songs on these machines is limited to their internal capacity for CD's and DVD's. Additionally, jukeboxes and Karaoke machines are typically stand alone machines that are not connected to any other device or other jukeboxes and Karaoke machines. Accordingly, the functionality of each machine is limited to the individual capability thereof. Current jukeboxes and Karaoke machines do not keep track of general user habits or habits of individual users who frequently use these machines. By not collecting general use data or date about particular users, these machines are very limited in their ability to market and promote the establishments where such machines are used.

### BRIEF DESCRIPTION OF THE DRAWINGS

FIG. 1 is a schematic block diagram of a video entertainment satellite network system constructed in accordance with the teachings of the instant disclosure.

### DETAILED DESCRIPTION

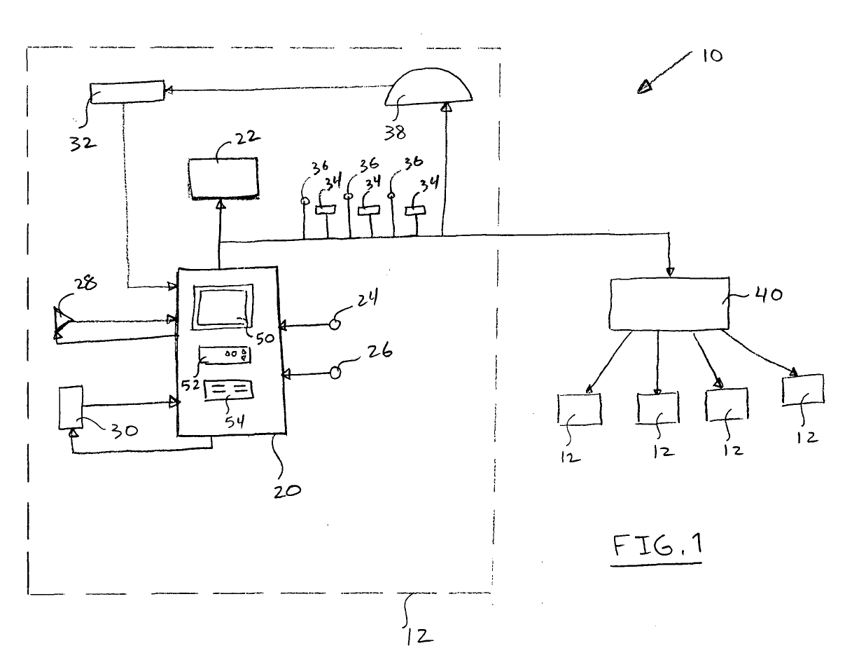

A video entertainment satellite network system 10 (“video network system 10”) is generally shown in FIG. 1. The video network system 10 includes a plurality of individual video entertainment satellite systems 12 (“video system 12”) that communicate with each other through the video network system 10. Accordingly, FIG. 1 shows the details of only one such video system 12 that is connected to the video network system 10 through a satellite network 40. The video network system 10 will allow a user of the system to play, record, and interact in selection of video music, perform Karaoke, record live events, and distribute real-time signals to video systems 12 in the video network system 10 by two-way satellite and internet communication.

Each video system 12 includes a video jukebox 20 that communicates with the video network system 10. The video jukebox 20 includes an audio/video panel 50, a control panel 52, and an access/use authorization panel 54. The audio/video panel 50 includes audio/video elements that are well known to those of ordinary skill in the art. For example, the audio/video panel 50 may include one or more display monitors and one or more speakers. The control panel 52 may include elements that are well known to those of ordinary skill in the art for controlling an audio/video system, such as the video jukebox 20. For example, the control panel 52 may include a volume knob (not shown) for adjusting the level of audio output from the audio/video panel 50, a plurality of knobs (not shown) for adjusting various video output settings of the audio/video panel 50, and various other buttons, knobs, and dials for controlling the video jukebox 20. In yet another example, the control panel 52 may be integrated into the audio/video panel 50 in a touch-screen configuration.

The video jukebox 20 communicates with a number of input and output devices. The video system 20 receives information from input devices, such as, a video camera 24, a plurality of user controlled input devices 26, an internet portal 28, a computer/server 30, and a satellite receiver 32. The video jukebox 20 outputs audio, video, and data signals to output devices, such as, video displays 22 and 34, speakers 36, the computer/server 30, and the internet portal 28. The output of the video jukebox 20 can be communicated within the video system 12, and/or to other video systems 12 in the video network system 10. The output of the video jukebox 20 can also be communicated to one or more performance stages 38 that may be at the location of the video system 12 and/or locations of other video systems 12 in the video network system 10. The video jukebox 20 can also receive audio and video from remote performance stages 38.

The video system 12 may be located a bar, restaurant, family game and entertainment center, sports arenas, or the like. The displays 22 and 34 of the video system 12 may be placed in strategic locations for distribution of audio and video to all persons who are in the locality of the video system 12. The display 22 may be a large-screen monitor for viewing by a large number of people. Such display 22 may be suitable for very large rooms or sport arenas. The displays 34 include smaller monitors which can be strategically distributed at various locations within the locality of the video system 12 to provide entertainment to virtually any user, whether located in a small room, large room, hallway, private room, or other small spaces. Each display device 22 and 34 also includes a speaker 36 for carrying audio. The audio/video panel 50 of the video jukebox 20 may include a three dimensional display device such as a halographic image generator, or three dimensional displays that require the user to wear particular glasses to see images in three dimensional format.

The video jukebox 20 receives information from input devices and sends information to the output devices. As discussed above, the input devices and the output devices may be part of the video system 12, i.e., located in proximity of the video jukebox 20, or may be located remotely in other video systems 12 of the video network system 10. Accordingly, each video jukebox 20 includes the capability to communicate (i.e., send and receive information) with local and remote input and output devices. The local communication capability of the video jukebox 20, which can be defined by communication within the video system 10, can be realized by either hardwire connectivity or wireless connectivity with the various local input and output devices.

The remote communication capability of the video jukebox 20, which can be defined by communication with other video systems 10 in the video network system 10 or other remote input/output devices, can be realized through the internet portal 28, and/or the satellite network 40, from which the satellite receiver 32 receives information. For example, the video jukebox 20 may send and receive information to other video systems 12 of the video network system 10 through the internet portal 28. Although each video system 12 includes a satellite receiver 32, it may also include a satellite transmitter (not shown) that can transmit information from the video jukebox 20 to other remoter venues, such as, other video systems 12 of the video network system 10. The satellite receiver 32 and transmitter (not shown) may be configured to operate within commonly used satellite signal frequencies that are well known to those of ordinary skill in the art, such as the Ku Band and the C Band, or other digital satellite frequencies. Accordingly, each video system 12 can provide two-way communication of audio and video information with any or all of the video systems 12 of the video network system 10, or other remote venues, such as a remote performance stage 38, by the internet portal 28 or satellite communication. Alternately, only the satellite network 40 can include satellite transmitters so that broadcasts from one or more video systems 12 can be broadcast to other video systems 12. One of ordinary skill in the art will appreciate that the capability of the video jukebox 20 to communicate through the internet allows the video jukebox 20 to serve as a public internet terminal. Accordingly, a user can simply view web pages or read email on the video jukebox 20 if such activity is desired. To increase the versatility of the video network system 10, each video system 10, and in particular, each video jukebox 20 is capable of recording and broadcasting video in all available formats, such as NTSC, PAL, MPEG 1, 2, and 4, as well as HDTV, and any other available video formats.

The user controlled input devices 26 may be any or a combination of a number of electronic input devices that are well known to those of ordinary skill in the art and are described in the following. The input devices 26 can include one or more tactile input devices such as a mouse, keyboard, joystick, game pad, and an input pad with a number of switches, knobs, buttons, dials, or the like. The input devices 26 also include audio input devices such as a hand held microphone (not shown), or a number of fixed microphones that are strategically placed on the video jukebox 20 to pick up audio input from a user and his surroundings. The hand held microphone also includes a key pad so that when the user is holding the microphone, he can also send text or commands to the video jukebox 20. The input devices 26 can include video devices such as an additional video camera (not shown). The input devices 26 can also include devices that can transfer audio or video information to the video jukebox 20 from electronic storage mediums, such as hard disk drives, memory card readers, readable and writable CD-ROM and DVD drives, tape drives, and other optical or magnetic storage devices. Accordingly, a user can supply his own previously arranged audio or video performance to the video jukebox 20 with the noted electronic storage devices. Additionally, the described electronic storage devices allow a user to store his audio and video productions while using the video jukebox 20. For example, a user can store his Karaoke performance on a DVD for a later viewing at home or another venue, such as another video system 12 of the video network system 10.

The source of Audio/video and graphic programs and performances for each video system 10 may be a storage device in the video jukebox 20, the computer/server 30, and/or the internet portal 28. The video jukebox 20 may include an internal inventory of audio/video and graphics programs and performances that are stored in electronic data storage devices, which a user can readily access. Audio/video programs that are not available in the video jukebox 20 may be available in the computer/server 30, which the user can access to retrieve such programs and performances. Audio/video programs that are neither available in the video jukebox 20 nor the computer/server 30, can be downloaded from the internet into the video jukebox 20 or the computer/server 30 through the internet portal 28. Accordingly, the audio/video panel 50 can display to a user the source of one or more requested performances or programs. When the user selects a program, the video jukebox 20 will either provide the program if store internally, retrieve the program from the computer/server 30 if the program is available therein, or download the program from the internet through the internet portal 28.

Furthermore, a user's own production or performance can be stored on the video jukebox 20, the computer/server 30, or a website on the internet. Accordingly, the user and others can retrieve his particular performance from a remote location, such as, another video jukebox 20 of a remote video system 12 of the video network system 10, or a remote computer system with internet connectivity. One of ordinary skill in the art will readily recognize that for others to access a user's performance, the user must authorize such access. Accordingly, when the user stores his performance on the jukebox 20, the computer/server 30, or the internet, he can set various levels of authorization so that one, a selected number, or all other users can access the performance.

The video system 12 is capable of Karaoke performances, closed circuit performances, and television performances. For example, a user can perform Karaoke on the video jukebox 20, which will be broadcasted on the audio/video displays 22, 34 and 36. Furthermore, users at other video systems 12 of the video network system 10 can view the user's performance. Also, the Karaoke performances that are available in the video network system 10 can be available in a large number of languages to allow the installation and use of the video system 12 in any global market.

The video network system 10 may be broadcasting a closed circuit performance through all or a selected number of the video systems 12 of the video network system 12. Accordingly, functionality of the video jukeboxes 20 of the video systems 12 that are selected for the closed circuit broadcast will be disabled so that the broadcast can be provided to users of the selected video systems 12 without interference from individual users at those sites. Accordingly, the video network system 10 will broadcast the close circuit performance simultaneously to the selected video systems 12. Each video system 12 can also broadcast television performances, either individually if the operator of the video system 12 desires, or as part of multiple video systems 12 in the video network system 10. Similar to closed circuit performances, the functionality of the selected video jukeboxes 20 can be disabled for broadcasting television performances. The video system 12 can also display commercials, promotional videos, and various marketing displays that are designed to market a product or service that is provided by the operator of the video system 12.

A user can substitute his image for an artist in a closed circuit performance or a television broadcast by having his image superimposed on the image of the selected artist. The video camera 24 can transmit the image of the user to the video jukebox 20, which in turn superimposes the image of the user on the image of the selected artist. Accordingly, the user can select through the control panel 52 of the video jukebox 20, for which artist he wishes his image to substitute.

The access/use authorization panel 54 allows a user access to the video system 12 through the video jukebox 20. Access may be in given to a user based on a number of criteria, including but not limited to, payment of a fee, a user access code, prepaid access, tokens, etc. Accordingly, the access/use authorization panel 54 may include one or more magnetic card readers (not shown) for reading prepaid access cards, memory cards, and credit cards. For instance, a user can pay for using the video system 12 by inserting his credit card in a corresponding slot (not shown) in the access/use authorization panel 54 and be charged a usage fee by the video system 12 based on an access time, access content, or a flat rate basis.

The access/use authorization panel 54 may also include a currency and/or token receiving slot (not shown). For example, a user can pay for using the video system 12 by inserting paper or coin currency into corresponding slots in the access/use authorization panel 54. Furthermore, a user can pay for using the video system 12 by inserting tokens that may have been issued by the operator of the video system 12 into corresponding slots on the access/use authorization panel 54. Such tokens may be issued by the operator on a promotional basis or in exchange for currency paid to the operator. For example, the operator of the video system 12 can issue a number of tokens depending on various amounts of purchase(s) made by the user from the operator's business. One of ordinary skill in the art will readily appreciate that because the video system 12 is connected to the internet, the control panel 54 may also provide direct debit of the usage fee for the video system 12 from the user's bank or credit card accounts through the internet after such debit is authorized by the user.

One of ordinary skill in the art will appreciate the numerous functional features, marketing tools, and statistical data collection features that can be utilized using access cards or memory cards when used in the video jukebox 20. An access card, which may be a memory card, can be issued to a user so that it remains with the user. Accordingly, data reflecting each user's habits when operating or using the video jukebox 20 in video system 12 or other video systems 12 of the video network system 10 can be recorded on the access card. The access card can serve as a membership card that may be issued by the operator of the video system 12 to a user based on the user meeting one or more criteria set out by the operator, such as, payment of a membership fee, purchasing a specific product or service, or meeting a user spending goal at the operator's place of business. Accordingly, a user can use the video jukebox 20 by inserting his access card in the access/use authorization panel without having to pay for each usage.

The access card can be purchased by a user and can include a fixed amount of usage time or units for the video jukebox 20. The user, however, can add additional usage time or units by either having the operator of the video system 12 add more to the access card, or simply inserting the access card into the access/use authorization panel and adding usage time or units by credit card payment, cash payment or direct debit. To encourage users to add more usage time or units to their access cards, the operator can utilize various promotional tactics, such as entering each user in a weekly drawing for a prize. Accordingly, using an access card in the video jukebox 20 can automatically enter the user of the access card in the drawing for the prize.

The access card can record information about the user, such as, a special status of a user (i.e., a VIP member), whether a user is a past Karaoke winner or another contest winner, and other frequent visitor status assignments such as, singer of the month, and member of the month. The access card can also store a user's personal information such as his birthday. Accordingly, an operator of the video system 12 can award a user free usage time for the video jukebox 20 if the user visits the operator's establishment on his birthday. The foregoing examples illustrate the unlimited marketing tools that may be available to an operator of a video system 12.

The video network system 10 can provide numerous functions that allow or require simultaneous participation of users from several video systems 12 of the video network system 10. A few examples of such functions are described in the following. However, one of ordinary skill in the art will appreciate that numerous other multiple remote user participation activities are possible with the video network system 10.

The video network system 10 can provide competition among artists who are located far from each other but have access to a video system 12 of the video network system 10. For instance, the video network system 10 can include control centers (i.e., operating locations, not shown) that can coordinate such competitions. Such competitions, which may be one-time or ongoing and can allow artists to compete locally, regionally and nationally. The video network system 10 will allow individual artists, who are members of and have access to one or several video systems 12 to retrieve up to date statistics regarding their competitive positions at any particular video jukebox 20 or remotely from the internet.

The video network system 10 will allow any subscribing member to bid on services of any particular and available artist through a proprietary auction, which can operate at all times and from all locations where video systems 12 are available, or remotely from the internet. The information necessary to the auction process will allow interactivity between the bidder(s) and additionally allow for viewing of performances and performers from any remote video system 12 location or the internet.

The video network system 10 will allow users to access any particular video/audio/date information. This information may be in individual video jukeboxes 20 or the computer/server 30 of a local or remote video system 12, or stored in the control center of the video network system 10. Such information can be downloaded by a user for immediate display wherever the user may be accessing such information through the internet or at a remote video jukebox 20.

The video network system 10 can track and record statistical data describing multiple levels of user participation, such as, data on the most popular performances, the least popular performance, and most plays in any category of music. Specific income per category of input device, i.e., credit card, reader card, membership card, etc. can also be tracked and recorded by the video network system 10. Such statistical data is later used to update the music data base of the video network system 10 and improve income for each video system 12.

Persons of ordinary skill in the art will appreciate that, although the teachings of the invention have been illustrated in connection with certain embodiments, there is no intent to limit the invention to such embodiments. On the contrary, the intention of this application is to cover all modifications and embodiments fairly falling within the scope of the teachings of the invention.

1. A video entertainment satellite network system comprising:
a plurality of video entertainment satellite systems, each video entertainment satellite system comprising a video jukebox adapted to receive inputs from a plurality of input devices and send output to a plurality of output devices; and
a satellite communication device;
wherein each video entertainment satellite system is adapted to communicate with other video entertainment satellite systems through a satellite communication network by the satellite communication device.

2. A video entertainment satellite network system according to claim 1, each video jukebox including an audio and video communication panel, a control panel and an access authorization panel.

3. A video entertainment satellite network system according to claim 2, wherein the access authorization panel comprises at least a memory card reader.

4. A video entertainment satellite network system according to claim 2, wherein the access authorization panel includes means for receiving a payment from a user, the payment authorizing the user to use the video jukebox.

5. A video entertainment satellite network system according to claim 1, each video entertainment satellite system including a computing and data storage device adapted for two-way communication with the video jukebox.

6. A video entertainment satellite network system according to claim 1, each video entertainment satellite system including a internet portal adapted to provide two-way communication with the internet for the video jukebox.

7. A video entertainment satellite network system according to claim 1, wherein the plurality of input devices includes a microphone.

8. A video entertainment satellite network system according to claim 1, wherein the plurality of input devices includes at least a video camera.

9. A video entertainment satellite network system according to claim 1, wherein the plurality of output devices include audio broadcast and video display devices.

10. A video entertainment satellite system comprising:
a video jukebox having an audio and video communication panel, a control panel and an access authorization panel;
a plurality of input devices adapted to provide input to the video jukebox from a user;
a plurality of audio and video output devices adapted to receive communication from the video jukebox and output the communication; and
means for communicating with at least another remotely located video jukebox.

11. A video entertainment satellite network system according to claim 10, wherein the access authorization panel comprises at least a memory card reader.

12. A video entertainment satellite network system according to claim 10, wherein the access authorization panel includes means for receiving a payment from a user, the payment authorizing the user to use the video jukebox.

13. A video entertainment satellite network system according to claim 10, each video entertainment satellite system including a computing and data storage device adapted for two-way communication with the video jukebox.

14. A video entertainment satellite network system according to claim 10, each video entertainment satellite system including a internet portal adapted to provide two-way communication with the internet for the video jukebox.

15. A video entertainment satellite network system according to claim 10, wherein the plurality of input devices includes a microphone.

16. A video entertainment satellite network system according to claim 10, wherein the plurality of input devices includes at least a video camera.

17. A method of providing networked satellite entertainment comprising:
connecting a plurality of video entertainment satellite systems to a communication network, each video entertainment satellite system including a video jukebox adapted to receive inputs from a plurality of input devices and send output to a plurality of output devices, wherein the output of the video jukebox is available to the plurality of video entertainment satellite systems through the communication network;
providing interactive audio and video at each video jukebox of each video entertainment satellite system, the interactive audio and video being provided pending a user communicating authorization for receiving the interactive audio and video to the video jukebox;
storing usage data of the interactive audio and video for the video jukebox of each video entertainment satellite system, wherein the usage data is available to the plurality of video entertainment satellite systems through the communication network; and
wherein each of the plurality of video entertainment satellite systems and the plurality of video entertainment satellite systems are adapted to vary operations characteristics thereof based on the usage data.

18. The method of claim 17, wherein each video entertainment satellite system includes a satellite communication device, and wherein the communication network is a satellite communication network.

19. The method of claim 17, wherein each video entertainment satellite system includes an internet communication portal, and wherein the communication network is adapted to operate through the internet portal by the internet.

20. The method of claim 17, wherein each video jukebox includes a memory card reader for storing and retrieving the usage data from a memory card of the user.
